(19) United States
(12) Patent Application Publication
(10) Pub. No.: US 2025/0239223 A1
(43) Pub. Date: Jul. 24, 2025

(54) DISPLAY DEVICE AND DRIVING METHOD THEREOF

(71) Applicant: LG Display Co., Ltd., Seoul (KR)

(72) Inventor: Changmo Yang, Paju-si (KR)

(73) Assignee: LG Display Co., Ltd., Seoul (KR)

(21) Appl. No.: 18/986,342

(22) Filed: Dec. 18, 2024

(30) Foreign Application Priority Data
Jan. 16, 2024 (KR) 10-2024-0006814

(51) Int. Cl. G09G 3/3233; G06T 7/246

(52) U.S. Cl. CPC G09G 3/3233; G06T 7/248; G06T 2207/10016; G09G 2300/0842; G09G 2300/0861; G09G 2310/08; G09G 2320/0261; G09G 2340/0435

(57) ABSTRACT

A display device adaptively adjusts drive frequency and a resolution based on image characteristics. The display device in one example includes a display panel, and a display driving circuit configured to analyze a motion degree of the input video signal and a detail degree of the input video signal to determine a resolution and a driving frequency and display an output video signal having the determined resolution and the driving frequency on the display panel. The motion degree of a first input video signal is less than or equal to a first time reference value and the detail degree of the first input video signal is greater than a space reference value. Further, the display driving circuit displays a first output video signal having a first resolution and a first driving frequency on the display panel.

### CROSS-REFERENCE TO RELATED APPLICATION

This application claims priority to Korean Patent Applications No. 10-2024-0006814 filed in the Republic of Korea on Jan. 16, 2024, the entire contents of which are hereby expressly incorporated by reference into the present application.

### BACKGROUND

### Technical Field

The present disclosure relates to a display device and a driving method thereof capable of adjusting a driving frequency and a resolution.

### Discussion of the Related Art

A display device can display various videos using a matrix of pixels disposed on its display panel.

The display device allows the user to set the driving frequency and a resolution, but since the driving frequency and the resolution set by a user are fixed, video quality issues can occur depending on the characteristics of the videos content.

In case that the display device is set to a low driving frequency by the user, it can cause motion blur problems when displaying videos with a lot of motion, or in case that it is set to a low resolution by the user, it can cause readability problems when displaying still videos due to difficulty in showing the details of the still videos.

### SUMMARY OF THE DISCLOSURE

Accordingly, the present disclosure is directed to providing a display device that substantially obviate one or more problems due to limitations and disadvantages of the related art.

An aspect of the present disclosure provides a display device and a driving method thereof capable of adaptively adjusting a driving frequency and a resolution based on video characteristics.

The problems to be solved by the examples of the present disclosure are not limited to those mentioned above, and other problems not mentioned will be apparent to one of ordinary skill in the art to which the technical spirits of the present disclosure belong from the following description.

A display device according to an embodiment of the present disclosure can include a display panel, and a display driving circuit configured to analyze a motion degree of an input video signal and a detail degree of the input video signal to determine a resolution and a driving frequency and display an output video signal having the determined resolution and the driving frequency on the display panel, wherein when the motion degree of a first input video signal is less than or equal to a first time reference value and the detail degree of the first input video signal is greater than a space reference value, the display driving circuit can display a first output video signal having a first resolution and a first driving frequency on the display panel, and wherein the first resolution is equal to a reference resolution of the display panel and the first driving frequency is less than or equal to a reference driving frequency of the display panel.

A driving method of a display device according to an embodiment of the present disclosure can include obtaining a previous frame data and a current frame data of an input video, calculating a time change amount representing a motion degree of the input video by comparing the previous frame data and the current frame data for each scan line, calculating a space change amount representing a detail degree of the input video by comparing the current frame data for each adjacent scan line, and determining a resolution and a driving frequency according to the time change amount and the space change amount to display an output video signal having the determined resolution and the determined driving frequency on a display panel.

A display device according to an embodiment of the present disclosure can include a display panel, and a display driving circuit configured to analyze a time change amount of an input video signal and a space change amount of the input video signal to determine a resolution and driving frequency and display an output video signal having the determined resolution and driving frequency on the display panel, wherein when the time change amount of a first input video signal is less than or equal to a first time reference value and the space change amount of the first input video signal is greater than a space reference value, the display driving circuit can display a first output video signal having a first resolution and a first driving frequency on the display panel, wherein when the time change amount of a second input video signal is greater than the first time reference value and less than or equal to a second time reference value, the display driving circuit can display a second output video signal having a second resolution and a second driving frequency on the display panel, and wherein first resolution is equal to a reference resolution of the display panel, the first driving frequency is less than or equal to a reference driving frequency of the display panel, the second resolution is less than the reference resolution, and the second driving frequency is greater than the reference driving frequency.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a block diagram schematically illustrating an example of a configuration of a display device, according to one embodiment of the present disclosure.

FIG. 2 is a diagram illustrating an example of a pixel matrix of a display device, according to one embodiment of the present disclosure.

FIG. 3 is a diagram schematically illustrating an example of a subpixel configuration of a display device, according to one embodiment of the present disclosure.

FIG. 4 is an equivalent circuit illustrating an example of a subpixel configuration of a display device, according to one embodiment of the present disclosure.

FIG. 5 is an equivalent circuit illustrating an example of a subpixel configuration of a display device, according to one embodiment of the present disclosure.

FIG. 6 is a flow diagram illustrating an example of a method of determining a mode during a method of driving a display device, according to one embodiment of the present disclosure.

FIG. 7 is a graph of illustrating an example of a relationship between a time change amount, a space change amount of a display device and a driving mode, according to one embodiment of the present disclosure.

FIG. 8 is a diagram illustrating an example of a scan drive waveform diagram of a first drive mode of a display device, according to one embodiment of the present disclosure.

FIG. 9 is a diagram illustrating an example of a scan drive waveform diagram of a second drive mode of a display device, according to one embodiment of the present disclosure.

FIGS. 10A and 10B are example diagrams illustrating a comparison of a first video displayed on a display device according to a comparison example and one embodiment of the present disclosure.

FIGS. 11A and 11B are example diagrams illustrating a comparison of a second video displayed on a display device according to a comparison example and one embodiment of the present disclosure.

FIG. 12 is a block diagram schematically illustrating an example of an inspection system for a display device, according to one embodiment of the present disclosure.

FIG. 13 is a schematic diagram illustrating an example test method for determining if a display device is applied, according to one embodiment of the present disclosure.

### DETAILED DESCRIPTION OF THE EMBODIMENTS

Reference will now be made in detail to the example embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present disclosure are used, another part can be added unless “only” is used. The terms of a singular form can include plural forms unless referred to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct (ly)” is used.

In describing a time relationship, for example, when the temporal order is described as, for example, “after,” “subsequent,” “next,” and “before,” a case that is not continuous can be included unless a more limiting term, such as “just,” “immediate (ly),” or “direct (ly)” is used.

It will be understood that, although the terms “first,” “second,” etc. can be used herein to describe various elements, these elements should not be limited by these terms. These terms are only used to distinguish one element from another and may not define order of sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc. can be used. These terms are intended to identify the corresponding elements from the other elements, and basis, order, or number of the corresponding elements should not be limited by these terms. As for the expression that an element is “connected,” “coupled,” or “adhered” to another element or layer, the element or layer can not only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the word “may.”

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

Hereinafter, embodiments of the present disclosure will be described in detail with reference to the accompanying drawings. All the components of each display device according to all embodiments of the present disclosure are operatively coupled and configured.

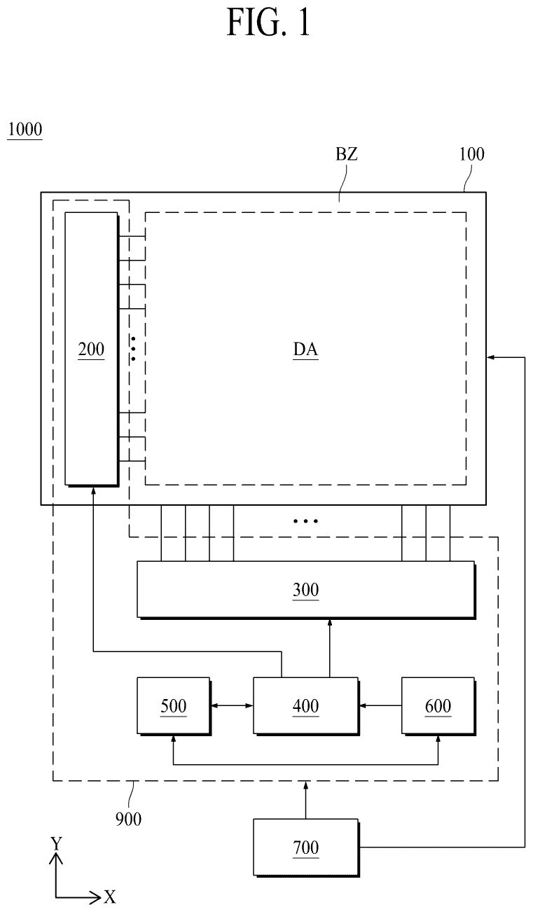

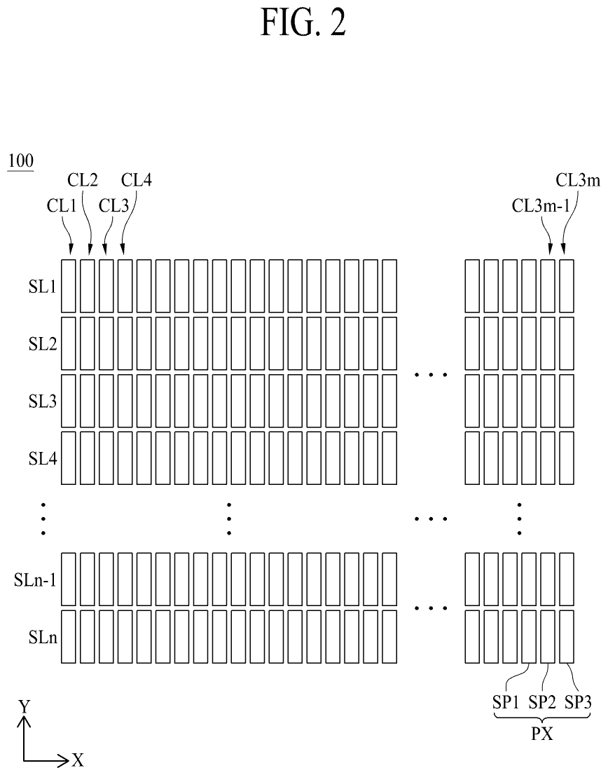

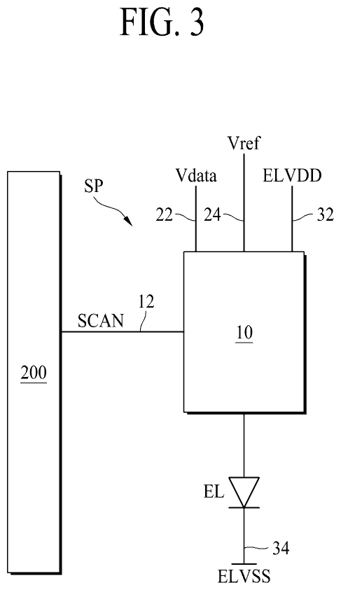

FIG. 1 is a block diagram schematically illustrating an example of a configuration of a display device according to one embodiment of the present disclosure, and FIG. 2 is a diagram illustrating an example of a pixel matrix of a display device according to one embodiment of the present disclosure. FIG. 3 is a diagram schematically illustrating an example of a subpixel configuration of a display device, according to one embodiment of the present disclosure.

A display device 1000, according to one embodiment, can be an Electroluminescent Display, including an Organic Light Emitting Diode (OLED) display device, a Quantum-dot Light Emitting Diode display device, or an Inorganic Light Emitting Diode display device. The display device 1000 according to one embodiment can be a Micro Light Emitting Diode display device, or a Liquid Crystal Display device.

Referring to FIG. 1, the display device 1000 according to one embodiment can include a display panel 100, a display driving circuit 900, and a power management circuit 700. The display driving circuit 900 can include a gate driver 200, a data driver 300, a timing controller 400, a memory 500, and a mode determining unit 600. In one embodiment, the mode determining unit 600 can be embedded in the timing controller 400.

The display panel 100 can be a rigid display panel, or it can be a flexible display panel that can be deformed, such as a foldable, bendable, rollable, or stretchable display panel.

The display panel 100 can include a display area DA that displays a video, and a bezel area BZ that is a non-display area surrounding and peripheral to the display area DA.

The display panel 100, according to one embodiment, can further include a touch sensor array disposed in the display area DA to sense a user's touch.

The display panel 100, according to one embodiment, can include a gate driver 200 disposed in at least one of a bezel region BZ and a display region DA. The plurality of transistors disposed in the display area DA of the display panel 100 and the bezel area BZ including the gate driver 200 can include at least one of an LTPS transistor utilizing a low temperature poly silicon (LTPS) semiconductor, an oxide transistor utilizing a metal-oxide semiconductor, and an oxide transistor utilizing a metal-oxide semiconductor. The display panel 100 according to one embodiment can be configured to include a mixture of LTPS transistors and oxide transistors to reduce power consumption.

Referring to FIGS. 1 and 2, the display panel 100 can display a video using a display area DA in which a plurality of subpixels SP1, SP3, SP3 are arranged in a matrix. The pixel matrix of the display panel 100 can include a plurality of scan lines (SL1 to SLn, where n is a positive integer) including the plurality of subpixels SP1, SP3, SP3 arranged in a first direction X and a plurality of column lines (CL1 to CL3m, where m is a positive integer) including the plurality of subpixels SP1, SP3, SP3 arranged in a second direction Y.

A pixel PX can include a plurality of subpixels SP1, SP3, SP3, but is not limited to. The plurality of subpixels SP1, SP3, SP3 can be red subpixels for emitting red light, green subpixels for emitting green light, and blue subpixels for emitting blue light. In one embodiment, the pixel PX can further comprise a white subpixel that emits white light. In one embodiment, the pixel PX can comprise two subpixels SP1, SP2 with different emission colors.

In the display panel 100, the pixel matrix can be driven by the gate driver 200 on a scan line by scan line basis, or dual scan line by dual scan line basis, or four scan line by four scan line basis, and while the corresponding scan line is driven, the data signal supplied from the data driver 300 can be charged to the subpixels SP1, SP3, SP3 of the corresponding scan line, respectively. The subpixels SP1, SP3, SP3 can hold the charged data signal and emit light of a brightness corresponding to the data signal.

Referring to FIG. 3, a subpixel SP according to one embodiment can include a light emitting element EL, a pixel circuit 10 driving the light-emitting element EL in response to a data signal Vdata. The light-emitting element EL can be any one of an organic light-emitting diode, a quantum dot light-emitting diode, an inorganic light-emitting diode, and a micro light-emitting diode.

The subpixel SP according to one embodiment can receive the data signal Vdata from the data driver 300 via at least one data line 22. The subpixel SP can receive a scan signal SCAN from the gate driver 200 via at least one gate line 12. The subpixel SP according to an embodiment can be supplied with a high potential power supply voltage ELVDD via the first power line 32 and a low potential power supply voltage ELVSS via the common electrode (cathode electrode) and the second power line 34 from the power management circuit 700. A reference voltage Vref can be supplied via reference line 24 from power management circuit 700 or data driver 300.

The power management integrated circuit (PMIC) 700 can utilize the input voltage to generate and supply a plurality of power voltages required for operation of the display driving circuit 900. The power management circuit 700 can generate and supply the high potential power supply voltage ELVDD, the low potential power supply voltage ELVSS, and the reference voltage Vref to the display panel 100. In one embodiment, the power management circuit 700 can supply the reference voltage Vref to the display panel 100 via the data driver 300.

In one embodiment, the power management circuit 700 can receive a power setting value from the timing controller 400 for each driving mode, including displaying mode, sensing mode, and the like, and can generate and output the high potential power supply voltage ELVDD, the low potential power supply voltage ELVSS, and the reference voltage Vref for each operation mode.

In one embodiment, the power management circuit 700 can further include sensing circuit. The sensing circuit of the power management circuit 700 can sense electrical characteristics of the display panel 100 via either of the power lines 32, 34 of the display panel 100, and can transmit the sensing data to the timing controller 400.

The gate driver 200 can be disposed in the bezel region BZ of the display panel 100, or can be distributed in the display area DA. The gate driver 200, according to one embodiment, can be embedded in a Gate In Panel (GIP) type comprising transistors formed in the same process as the transistors in the display area DA. The gate driver 200 according to one embodiment can be disposed in at least one of the bezel zones BZ facing with the display area DA interposed therebetween.

The gate driver 200 can be controlled according to a plurality of gate control signals supplied from the timing controller 400, and can individually drive the gate lines of the display panel 100. The gate driver 200 can supply the scan signal SCAN of a gate-on voltage to the corresponding gate line during a drive period of each gate line, and a gate-off voltage to the corresponding gate line during a non-drive period of each gate line.

In one embodiment, the gate driver 200 can drive the gate lines by scan line basis, or by dual scan line basis, or by four scan line basis, depending on the drive mode control of the timing controller 400.

The data driver 300 can convert digital data supplied with data control signals from the timing controller 400 into analog data signals to supply data voltages Vdata to the data lines 22 of the display panel 100. The data driver 300 can include a gamma voltage generator, and can convert digital data to analog data voltages using gamma voltages supplied from the gamma voltage generator.

In one embodiment, the data driver 300 can receive the reference voltage Vref from the power management circuit 700 for each driving mode, and can supply the reference voltage Vref to the reference line 24 of the display panel 100 for each driving mode under the control of the timing controller 400.

In one embodiment, the data driver 300 can further include sensing circuit. The sensing circuit of the data driver 300 can sense signals reflecting electrical characteristics of the subpixel SP via the reference line 24 in a voltage sensing manner or a current sensing manner, and can transmit the sensing data to the timing controller 400.

The data driver 300 can include at least one data drive IC (integrated circuit) that drives a plurality of data lines 22 disposed on the display panel 100. Each data drive IC can be mounted on a circuit film and connected with the display panel 100. The circuit films on which the data drive ICs are mounted can be electrically connected to the display panel 100 and bonded to pad areas disposed on the bezel region BZ of the display panel 100 via an anisotropic conductive film (ACF). The circuit film can be any one of chip on film (COF), flexible printed circuit (FPC), and flexible flat cable (FFC).

The timing controller 400 can receive timing control signals and video data from a host system or the mode determining unit 600. The host system can be any of a computer, a television system, a set-top box, a system on a mobile device such as a tablet or cell phone, or an automotive system. The timing control signals can include a dot clock, a data enable signal, a vertical synchronization signal, a horizontal synchronization signal, and the like.

The timing controller 400 can control the operation of the gate driver 200 and the data driver 300 using the supplied timing control signals and internally stored timing setting information. The timing controller 400 can generate gate control signals to control the operation of the gate driver 200, and can generate data control signals to control the operation of the data driver 300.

The timing controller 400 can perform various video processing using the supplied video data, including video quality correction, afterimage compensation, luminance correction to reduce power consumption, and the like, and output the video data corrected by the video processing to the data driver 300.

In one embodiment, the timing controller 400 can utilize a Peak Luminance Control (PLC) method to control the peak luminance based on the video data. The timing controller 400 can determine an average picture level (APL) of the video data, and the higher the APL, the lower the peak luminance can be set to reduce power consumption.

In one embodiment, the timing controller 400 can operate the display device 1000 in a sensing mode. In sensing mode, the timing controller 400 can be supplied with sensing data that senses electrical characteristics of the display panel 100 via sensing circuit embedded in either of the data driver 300 and the power management circuit 700.

In one embodiment, the timing controller 400 can accumulate video data and determine a sensing region by predicting a deterioration region in the display panel 100 based on the accumulated data. In sensing mode, the timing controller 400 can be supplied with sensing data that senses electrical characteristics of the sensing region of the display panel 100 using the data driver 300 or the power management circuit 700.

The timing controller 400 can calculate the amount of change in the electrical characteristics (threshold voltage shift value) of the drive transistors and/or light emitting elements ELs of the subpixel SP based on the sensing data and can calculate and store a compensation value in the memory 500 to compensate for the change. The timing controller 400 can compensate the video data by applying the compensation value stored in the memory 500 to compensate for luminance differences due to deviations in the characteristics of the subpixels SP, or to compensate for afterimage due to degradation.

Sensing modes of the display device 1000, according to one embodiment, can be performed in response to instructions from the host system, can be performed in response to a user request via the host system, or can be performed in response to an actuation sequence determined by the timing controller 400.

The mode determining unit 600 according to one embodiment can receive video data input from the host system via the memory 500. The mode determining unit 600 can analyze video characteristics such as motion degree and detail degree of the input video data to adaptively determine an optimal resolution.

In one embodiment, the mode determining unit 600 can derive motion data representing a motion degree of the current frame video and detail data representing a detail degree by comparatively analyzing a video data of the previous frame and the current frame using the video data stored in the memory 500. In one embodiment, the mode determining unit 600 can compare and analyze the video data of the previous frame and the current frame by scan line to generate motion data representing a time change amount of the video data and detail data representing a space change amount of the video data.

In one embodiment, the motion data can be represented by a Temporal Index representing the time change amount of the video data over time. The detail data can be represented by a Spatial Index, representing the change amount of the video data over space.

In one embodiment, the mode determining unit 600 can determine an optimal resolution and driving frequency for the input video based on the motion data and detail data derived by the video analysis and can transmit the determined resolution and driving frequency or a driving mode representing the determined resolution and driving frequency to the timing controller 400. The timing controller 400 can control driving the gate driver 200 and the data driver 300 in accordance with the resolution and driving frequency of the determined driving mode, thereby displaying the video on the display panel 100 at a resolution and driving frequency suitable for the video characteristics. A specific description of this will be described later.

As such, the display device 1000 according to one embodiment can analyze the input video characteristics to adaptively determine and apply an optimal resolution and driving frequency according to the video characteristics, thereby improving video quality as well as achieving a low power consumption effect.

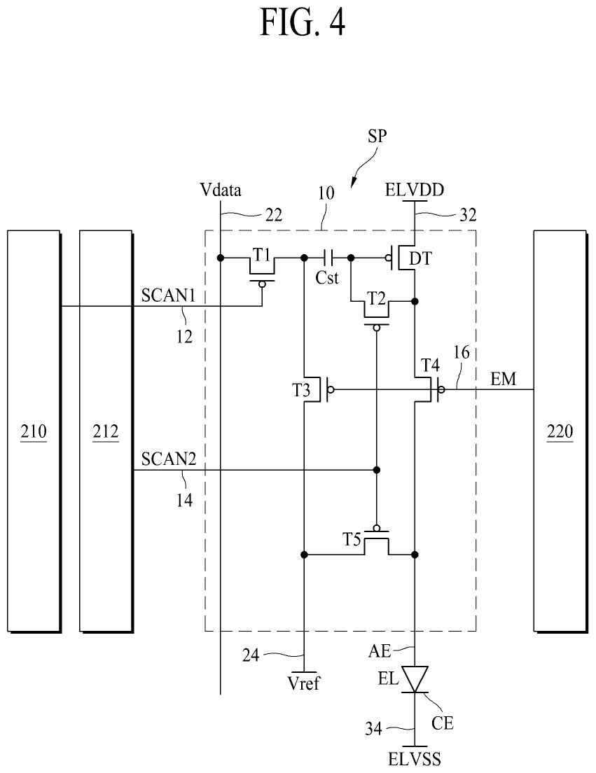

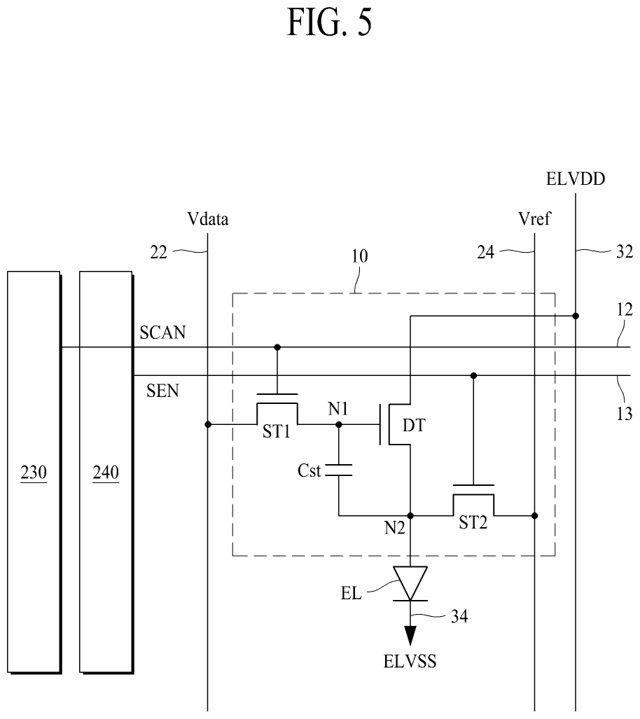

FIGS. 4 and 5 are equivalent circuits illustrating an example of a subpixel configuration of a display device, according to one embodiment of the present disclosure.

Referring to FIGS. 4 and 5, a subpixel SP according to one embodiment can include the light-emitting element EL and a pixel circuit 10 driving the light emitting element EL. In one embodiment, the pixel circuit 10 can include a drive transistor DT, a plurality of switching transistors T1 to T5 or ST1-ST2, and a storage capacitor Cst, but is not limited to.

Each of the drive transistor DT and the plurality of switching transistors T1 to T5 or ST1-ST2 of the pixel circuit 10 includes a gate electrode, a source electrode, and a drain electrode. Since the source electrode and the drain electrode are not fixed and can change depending on the direction of the voltage and current applied to the gate electrode, one of the source electrode and the drain electrode can be represented as the first electrode and the other as the second electrode. The drive transistor DT and the plurality of switching transistors T1 to T5 or ST1-ST2 of the pixel circuit 10 can utilize at least one of a polysilicon semiconductor, an amorphous silicon semiconductor, and an oxide semiconductor, and can be P-type or N-type, or a mixture of P-type and N-type.

The pixel circuit 10 can receive the data signal Vdata from the data driver 300 (FIG. 1) via the data line 22. The pixel circuit 10 can receive the high potential power supply voltage ELVDD via a first power line 32 and the low potential power supply voltage ELVSS via a second power line 34 and a common electrode (cathode electrode) CE from the power management circuit 700 (FIG. 1). The pixel circuit 10 can be supplied with the reference voltage Vref via the reference line 24 from the power management circuit 700 or the data driver 300.

Referring to FIG. 4, the gate drivers according to one embodiment can include first and second scan drivers 210, 212 driving the first and second gate lines 12, 14, respectively, and a light emission control driver 220 driving the third gate line 16. The number of gate lines 12, 14, 16 connected with the subpixel SP, the number of scan drivers 210, 212, and the number of light emission control drivers 220 can be varied depending on the detailed configuration of the pixel circuit 10 comprising the subpixel SP.

The pixel circuit 10 can be supplied a first scan signal SCAN1 via the first gate line 12 from a first scan driver 210, and a second scan signal SCAN2 via the second gate line 14 from the second scan driver 212. The pixel circuit 10 can be supplied with an emission control signal EM via the third gate line 16 from the emission control driver 220.

In one embodiment, the subpixel SP can be driven to include an Initial period, a Sampling and Writing period, and an Emission period for each frame period.

The light-emitting element EL can comprise an anode electrode AE connected to the fourth switching transistor T4, a cathode electrode CE connected to the second power line 34 supplying the low potential power supply voltage ELVSS, and a light emitting layer between the anode electrode AE and the cathode electrode CE. When a drive current is supplied from the drive transistor DT through the fourth switching transistor T4, the light-emitting element EL can emit light with a brightness proportional to the current value of the drive current by injecting electrons from the cathode electrode CE into the light-emitting layer and holes from the anode electrode AE into the light-emitting layer, and by emitting fluorescent or phosphorescent material by recombination of electrons and holes in the light-emitting layer.

The gate electrode of the drive transistor DT can be connected with the storage capacitor Cst, the first electrode can be connected with the first power line 32 supplying the high potential power supply voltage ELVDD, and the second electrode can be connected with the first electrode of the fourth switching transistor T4. The drive transistor DT can be connected to the light-emitting element EL via the fourth switching transistor T4, and can drive the light-emitting element EL via the fourth switching transistor T4. The drive transistor DT can control the light emitting intensity of the light-emitting element EL through the fourth switching transistor T4 by controlling the drive current according to the drive voltage charged on the storage capacitor Cst.

The storage capacitor Cst can be connected between the second electrode of the first switching transistor T1 and the gate electrode of the drive transistor DT to charge a drive voltage corresponding to the data voltage Vdata. The storage capacitor Cst can hold the charged drive voltage, during the emission period when the first switching transistor T1 is turned off, and supply it to the drive transistor DT.

The first switching transistor T1 can be turned on or turned off in response to the first scan signal SCAN1 on the first gate line 12 disposed on the i-th (i is a natural number) pixel low line. The first switching transistor T1 can supply the data voltage Vdata supplied via the data line 22 to the first electrode of the storage capacitor Cst during the sampling and writing period in which the first scan signal SCAN1 has a gate-on voltage VON. The switching transistor T1 can be turned off during the initial period and the emission period when the first scan signal SCAN1 has a gate-off voltage VOFF.

The second and fifth switching transistors T2, T5 can be turned on or turned off in response to a second scan signal SCAN2 supplied to the second gate line 14 of the i-th pixel low line. The second and fifth switching transistors T2, T5 can be turned on during the initial period and the sampling and writing period when the second scan signal SCAN2 has a gate-on voltage VON, and can be turned off during the emission period when the second scan signal SCAN2 has a gate-off voltage VOFF.

The second switching transistor T2 can connect the drive transistor DT into a diode structure by connecting the gate electrode and the second electrode of the drive transistor DT during the initial period and the sampling and writing period in response to the second scan signal SCAN2. The second switching transistor T2 can compensate by charging the threshold voltage Vth of the drive transistor DT for the storage capacitor Cst. Accordingly, the storage capacitor Cst can charge a data voltage at which the threshold voltage Vth of the drive transistor DT is compensated.

The fifth switching transistor T5 can supply the reference voltage Vref supplied via the reference line 24 to the anode electrode AE of the light-emitting element EL during the initial period and the sampling and writing period in response to the second scan signal SCAN2.

The third and fourth switching transistors T3, T4 can be turned on or turned off in response to the emission control signal EM supplied to the third gate line 16 of the i-th pixel low line. The third and fourth switching transistors T3, T4 can be turned on during an initial period and the emission period when the emission control signal EM has a gate-on voltage VON, and can be turned off during the sampling and writing period when the emission control signal EM has a gate-off voltage VOFF.

The third switching transistor T3 can supply the reference voltage Vref supplied via the reference line 24 to the first electrode of the storage capacitor Cst during the initial period and the emission period in response to the emission control signal EM.

The fourth switching transistor T4 can connect the drive transistor DT to the light-emitting element EL during the initial period and the emission period in response to the emission control signal EM.

During the emission period of each frame, the drive transistor DT can drive the light-emitting element EL via the fourth switching transistor T4.

Referring to FIG. 5, the gate driver 200 according to one embodiment can include the scan driver 230 driving the first gate line 12, and a sense control driver 240 driving the second gate line 13.

The first switching transistor ST1 can be driven in response to the scan signal SCAN supplied to the first gate line 12 from the scan driver 230, and the data voltage Vdata supplied to the data line 22 from the data driver 300 (FIG. 1), can be supplied to the gate node N1 of the drive transistor DT.

The second switching transistor ST2 is driven in response to a sense control signal SEN supplied to the second gate line 13 from the sense control driver 240, and the reference voltage Vref supplied to the reference line 24 from the data driver 300 (FIG. 1) can be supplied to the source node N2 of the drive transistor DT. Meanwhile, when in the sensing mode, the second switching transistor ST2 can provide a current reflecting the electrical characteristics of the drive transistor DT or the electrical characteristics of the light-emitting element EL to the reference line 24.

The storage capacitor Cst connected between the gate node N1 and the source node N2 of the drive transistor DT can charge a difference voltage between the data voltage Vdata and the reference voltage Vref supplied to the gate node N1 and the source node N2 through the first, second switching transistor ST1,ST2, respectively, as the driving voltage of the driving transistor DT, and hold the charged driving voltage during the emission period when the first and second switching transistor ST1,ST2 are turned off.

The drive transistor DT can control the emission intensity of the light-emitting element EL by controlling the current flowing to the light-emitting element EL according to the drive voltage charged to the storage capacitor Cst.

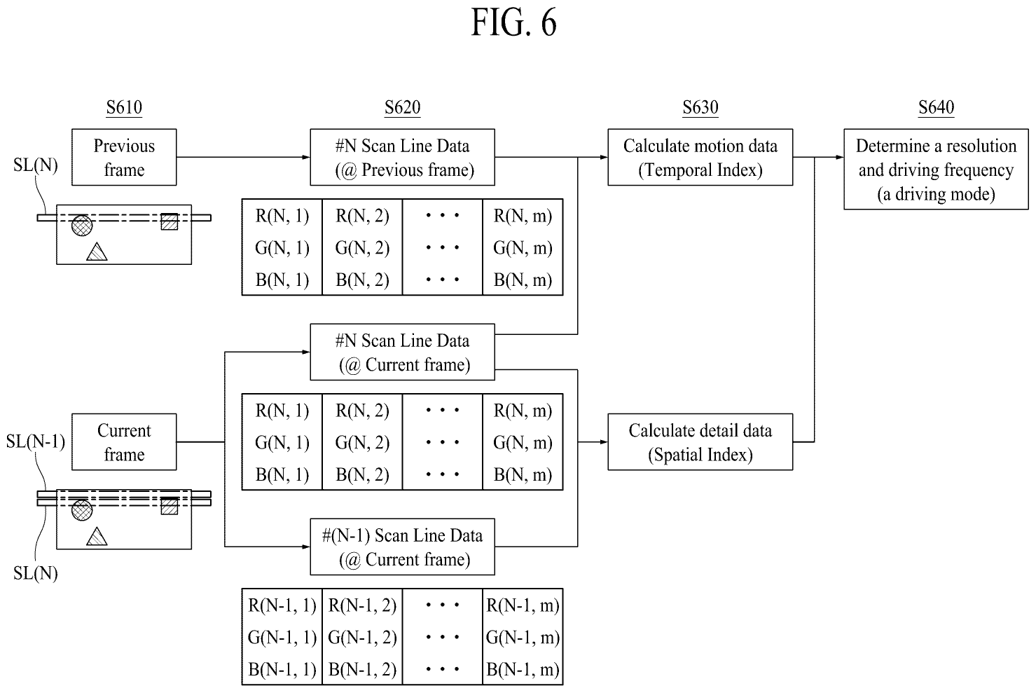

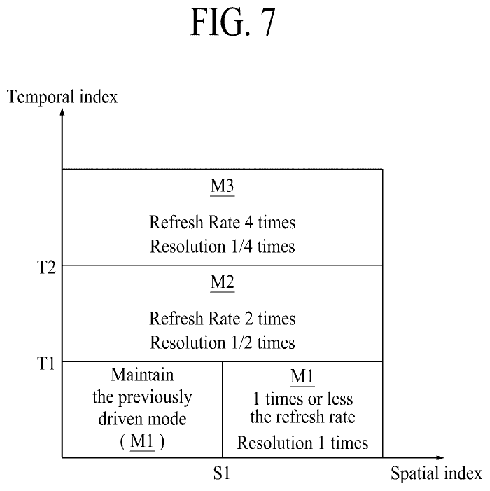

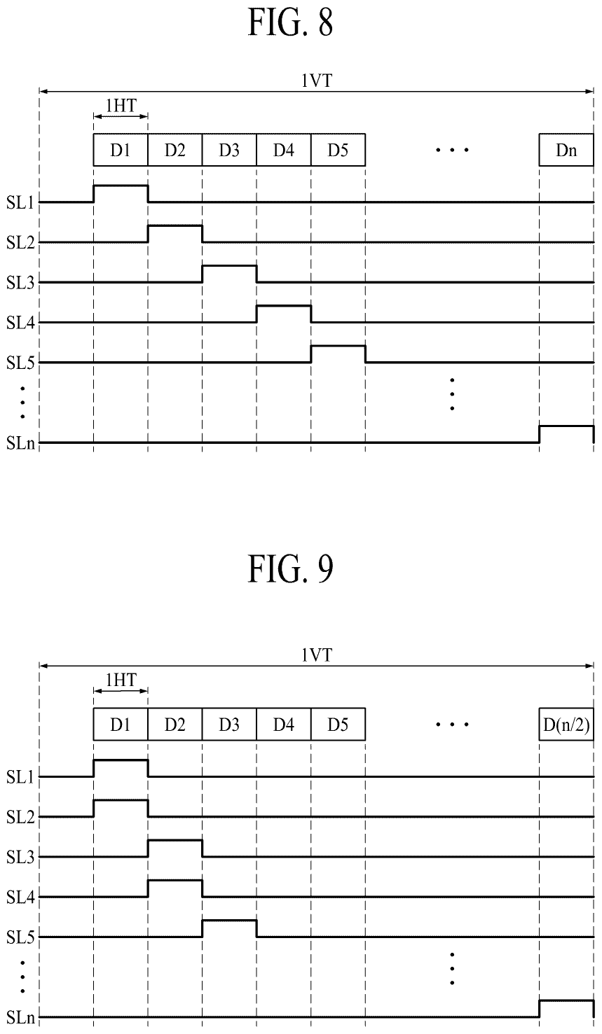

FIG. 6 is a flow diagram illustrating an example of a method of determining a mode during a method of driving a display device, according to one embodiment of the present disclosure. FIG. 7 is an example graph of illustrating an example of a relationship between a time change amount, a space change amount of a display device and a driving mode, according to one embodiment of the present disclosure. FIG. 8 is a diagram illustrating an example of a scan drive waveform diagram of a first drive mode of a display device, according to one embodiment of the present disclosure. FIG. 9 is a diagram illustrating an example of a scan drive waveform diagram of a second drive mode of a display device, according to one embodiment of the present disclosure.

Referring now to FIG. 6, a method for determining a mode of a display device according to one embodiment will be described with reference to FIG. 1, as it can be performed by the mode determining unit 600 shown in FIG. 1, or can be performed by the mode determining unit 600 embedded in the timing controller 400.

A method of determining a mode of a display device, according to an embodiment, can include steps S610, S620 of acquiring the video data, steps S630 of analyzing the video data to calculate the motion data (Temporal Index) and the detail data (Spatial Index), and steps S640 of determining a resolution and driving frequency.

In one embodiment, the steps S610, S620 of acquiring video data can include a step of S610 of acquiring video data of the current frame and the previous frame, and a step S620 of acquiring data for each scan line.

The mode determining unit 600, according to one embodiment, can acquire the video data of the previous frame and the video data of the current frame input from the outside and stored in the memory 500 (S610).

The mode determining unit 600 can acquire the video data R (N, 1), G (N, 1), B (N, 1) to R (N, m), G (N, m), B (N, m) of the Nth (N is a positive integer) scan line SL (N) from the video data of the previous frame using the line memory. The mode determining unit 600 can acquire the video data R (N−1, 1), G (N−1, 1), B (N−1, 1) to R (N−1, m), G (N−1, m), B (N−1, m) of the N−1th scan line SL (N−1), and the video data R (N, 1), G (N, 1), B (N, 1) to R (N, m), G (N, m), B (N, m) of the Nth scan line SL (N) from the video data of the current frame (S620).

The mode determining unit 600 can calculate the time change amount of the video data with respect to time of each scan line by comparing the video data of the previous frame and the video data of the current frame on a scan line-by-scan line basis and can generate the motion data, i.e., the temporal index by calculating an average value for the time change amount of the video data for all scan lines (S630).

The mode determining unit 600 can calculate the space change amount of the video data with respect to space of each scan line by comparing the video data of adjacent scan lines SL (N−1), SL (N) in the current frame on a scan line-by-scan line basis, and can generate detail data, i.e., the spatial index by calculating an average value for the space change amount of the video data of all scan lines (S630).

The mode determining unit 600 can calculate the difference between the video data R (N, 1), G (N, 1), B (N, 1) to R (N, m), G (N, m), B (N, m) of the Nth scan line SL (N) of the previous frame and the video data R (N, 1), G (N, 1), B (N, 1) to R (N, m), G (N, m), B (N, m) of the Nth scan line SL (N) of the current frame by color. The mode determining unit 600 can sum the calculated differences by color and divide the summed value by the total number m of video data by color of one scan line to calculate the time change amount of the video data with respect to time of each scan line.

The mode determining unit 600 can calculate and output an average value, for example, the temporal index by summing up all of the time change amounts of the video data calculated with respect to time for each scan line, dividing the sum value by the total number n of the scan lines as the motion data of the current frame (S630).

The mode determining unit 600 can calculate the differences between the video data R (N−1, 1), G (N−1, 1), B (N−1, 1) to R (N−1, m), G (N−1, m), B (N−1, m) of the N−1st scan line SL (N−1) of the current frame and the video data R (N, 1), G (N, 1), B (N, 1) to R (N, m), G (N, m), B (N, m) of the Nth scan line SL (N) by color. The mode determining unit 600 can sum the calculated differences and divide the sum value by the total number m of the video data by color of one scan line to calculate the space change amount of the video data of each scan line.

The mode determining unit 600 can calculate and output an average value as the detail data of the current frame, for example, the spatial index by summing all of the space change amounts of the video data calculated with respect to space for each scan line, dividing the sum value by the total number n of the scan lines (S630).

The mode determining unit 600 can determine a resolution and driving frequency suitable for the current frame video based on the motion data (the temporal index) and the detail data (the spatial index) of the current frame video calculated through the video analysis, and can determine a driving mode according to the resolution and driving frequency (S640).

The mode determining unit 600, according to one embodiment, can determine a resolution and driving frequency based on the magnitudes of the spatial index of the current frame video and the magnitudes of the temporal index of the current frame video, and can determine a driving mode representing the determined resolution and driving frequency.

Referring to FIG. 7, in one embodiment, when the spatial index of the current frame video is less than or equal to the space reference value S1 and the temporal index is less than or equal to a first time reference value T1, the mode determining unit 600 can determine the driving mode to a previous mode in which the resolution and driving frequency are maintained the same as in the previously driven mode. In one embodiment, when the spatial index of the current frame video is greater than the space reference value S1 and the temporal index is less than or equal to the first time reference value T1, the mode determining unit 600 can determine a resolution to a first resolution (Resolution 1 times) corresponding to the reference resolution, driving frequency to a first driving frequency (1 times or less the refresh rate) equal to or smaller than the reference driving frequency, and the driving mode to a first driving mode (M1).

For example, when the display panel 100 of the display device 1000 according to one embodiment has an ultra-high definition (UHD) high resolution, the reference resolution (the first resolution) can be set to a 3840×2160 resolution (1 times the resolution) that is the same as the reference resolution of the display panel 100, and the reference driving frequency (the first driving frequency) can be set to 120 Hz (1 times the refresh rate).

On the other hand, in one embodiment, even when the spatial index of the current frame video is equal to or less than the space reference value S1 and the temporal index of the current frame video is equal to or less than the first time reference value T1, the mode determining unit 600 can determine the driving mode to the first driving mode M1 having the first resolution (1 times resolution) and the first driving frequency (1 times or less refresh rate) or less, instead of maintaining the previously driven mode described above.

Referring to FIGS. 1, 7, and 8, when the mode determining unit 600 determines a first driving mode M1 having the first resolution (1 times resolution) and the first driving frequency (1 times or less refresh rate), the timing controller 400 can control the driving of the gate driver 200 and the data driver 300 at the first resolution (1 times resolution) and a driving frequency equal to or less than the first driving frequency (1 times or less refresh rate) of the first driving mode M1, which is a normal mode.

The plurality of scan lines SL1 to SLn of the display panel 100 can charge the subpixels with the data signals D1 to Dn supplied from the data driver 300 when the gate driver 200 sequentially drives in a scan line-by-scan line basis for one vertical synchronization period (1VT). Accordingly, the display panel 100 can display a video having the first vertical resolution equal to the total number n of scan lines SL1 to SLn, for example, a video having the first resolution equal to the reference resolution of the display panel 100, at the driving frequency equal to or smaller than first driving frequency (1 times or less refresh rate).

In one embodiment, when the temporal index is between the first time reference value T1 and the second time reference value T2, regardless of the spatial index of the current frame video, the mode determining unit 600 can determine the resolution to a second resolution that is ½ times of the first resolution, determine the driving frequency to a second driving frequency that is 2 times of the first driving frequency, and can determine the driving mode to a second driving mode M2.

Referring to FIGS. 1, 7, and 9, when the mode determining unit 600 determines to the second driving mode M2 having the second resolution (½ times the resolution) and the second driving frequency (2 times the refresh rate), the timing controller 400 can control the driving of the gate driver 200 and the data driver 300 at the second resolution (½ times the resolution) and the second driving frequency (2 times the refresh rate) of the second driving mode M2.

The plurality of scan lines SL1 to SLn of the display panel 100 can charge the subpixels with the data signals D1 to Dn/2 supplied from the data driver 300 when the gate driver 200 sequentially drives in a dual scan line-by-dual scan line basis for one vertical synchronization period 1VT. Accordingly, the display panel 100 can display a video having the second vertical resolution reduced to ½ times of the total number n of scan lines SL1 to SLn, for example, a video having a second resolution reduced to ½ times of the reference resolution of the display panel 100, can be displayed at the second driving frequency (2 times refresh rate) increased to 2 times of the first driving frequency. The gate driver 200 according to one embodiment can drive the (2N−1)th (where N is a positive integer) and 2Nth scan lines simultaneously.

In one embodiment, when the temporal index is greater than the second time reference value T2, regardless of the spatial index of the current frame video, the mode determining unit 600 can determine the resolution to a third resolution that is one-quarter times of the first resolution, can determine the driving frequency to a third driving frequency that is four times of the first driving frequency, and can determine the driving mode to a third driving mode M3.

Referring to FIGS. 1 and 7, when the mode determining unit 600 determines the driving mode to the third driving mode M3 having the third resolution (¼ times the resolution) and the third driving frequency (4 times the refresh rate), the timing controller 400 can control the driving of the gate driver 200 and the data driver 300 at the third resolution (¼ times the resolution) and the third driving frequency (4 times the refresh rate) of the third driving mode M3.

The plurality of scan lines SL1 to SLn of the display panel 100 can charge the subpixels with the data signals D1 to Dn/4 supplied from the data driver 300 when the gate driver 200 sequentially drives in a four scan line-by-four scan line basis for one vertical synchronization period 1VT. Accordingly, the display panel 100 can display a video having the third vertical resolution reduced to one-quarter of the total number n of scan lines SL1 to SLn, for example, a video having the third resolution reduced to one-quarter of the reference resolution of the display panel 100, at the third driving frequency (4 times the refresh rate) increased to four times of the first driving frequency. The gate driver 200 according to one embodiment can drive the (4N−3)th, (4N−2)th, (4N−1)th, and 4Nth scan lines simultaneously.

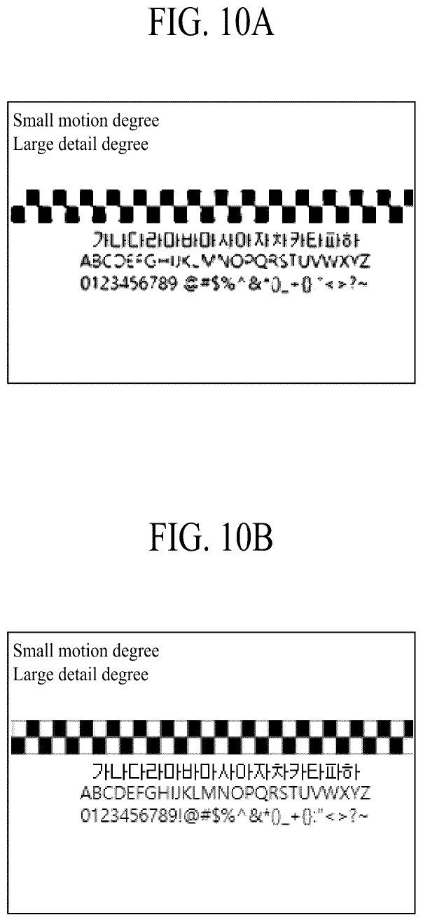

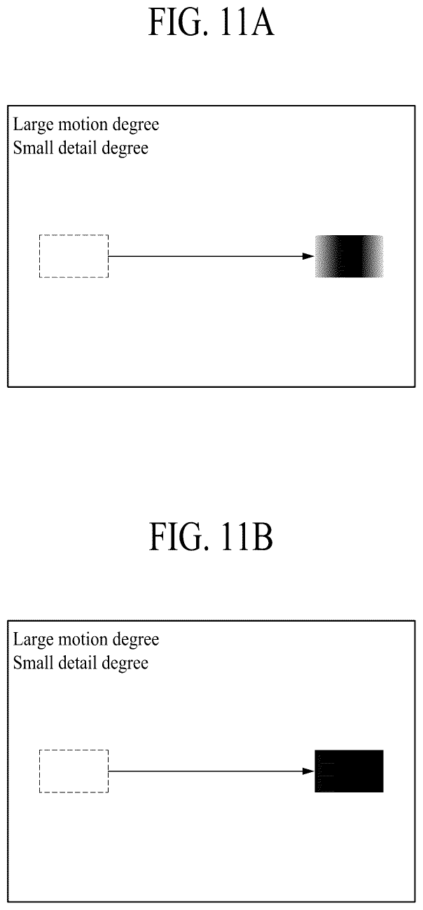

FIGS. 10A and 10B are example diagrams illustrating a comparison of a first video displayed on a display device according to a comparison example and one embodiment of the present disclosure. FIGS. 11A and 11B are example diagrams illustrating a comparison of a second video displayed on a display device according to a comparison example and one embodiment of the present disclosure.

Referring to FIG. 10A, in case that the driving mode of the display device according to the comparative example is set by a user to a low resolution (½ of the reference resolution=vertical resolution 1080) and a high-speed driving (2 times the reference driving frequency=240 Hz), when displaying a still video having a small motion degree and a large detail degree, it can be difficult to express a detail part in the video, thereby resulting in a decrease in readability.

On the other hand, referring to FIG. 10B, it can be seen that the display device according to one embodiment displays the still video by adjusting to a high resolution (reference resolution=vertical resolution 2160) and a low speed driving (reference driving frequency 1 times=120 Hz) according to the characteristics of the still video having a small motion degree (the time change amount, the motion data, or the temporal index is small) and a large detail degree (the space change amount, the detail data, or the spatial index is large), therefore the details are clearly displayed and readability is improved.

Referring to FIG. 11A, in case that the driving mode of the display device according to the comparative example is set by a user to high resolution (reference resolution=vertical resolution 2160) and low speed driving (reference driving frequency 1 times=120 Hz), motion blur can occur when displaying a movie having a large motion degree and a small detail degree.

On the other hand, referring to FIG. 11B, it can be seen that the display device according to one embodiment displays videos by adjusting to a low resolution (½ of the reference resolution=vertical resolution 1080) and a high-speed driving (2 times the reference driving frequency=240 Hz) according to the characteristics of the videos having a large motion degree (the time change amount, the motion data, or the temporal index is large) and a small detail degree (the space change amount, the detail data, or the spatial index is small), therefore the videos is displayed clearly without motion blur, thereby improving the video quality.

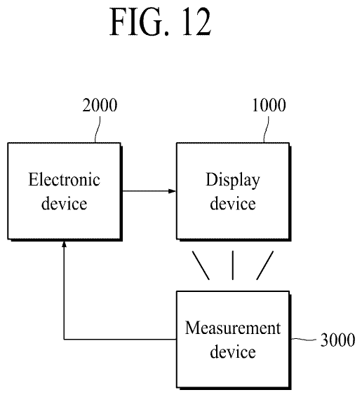

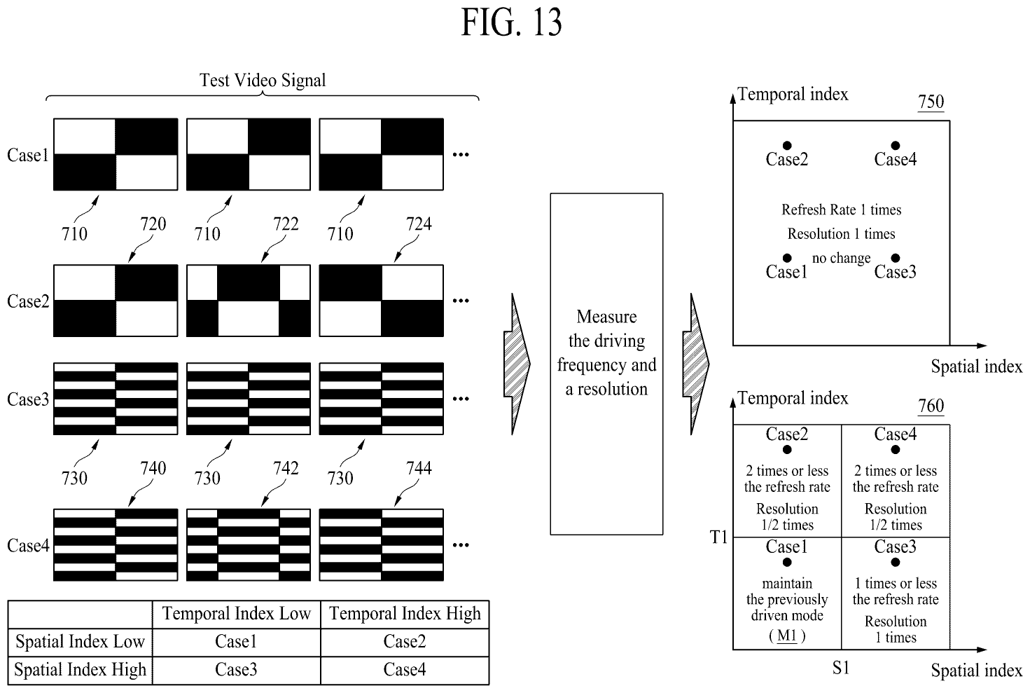

FIG. 12 is a block diagram schematically illustrating an inspection system for a display device, according to one embodiment of the present disclosure, and FIG. 13 is a schematic diagram illustrating an example test method for determining if a display device is applied, according to one embodiment of the present disclosure.

Referring to FIG. 12, an inspection system for a display device can include a display device 1000, an electronic device 2000, and a measurement device 3000.

The display device 1000 can receive test videos from the electronic device 2000 to measure driving frequency and a resolution changes and display them on the display panel 100, FIG. 1.

The electronic device 2000 can generate test videos having the motion degree (the time change amount or the temporal index) and the detail degree (the space change amount or the spatial index) that are clearly distinguishable and supply them to the display device 1000. The display device 1000 can sequentially display the test videos supplied from the electronic device 2000.

In one embodiment, the test videos can include videos from the first to fourth cases (Case1, Case2, Case3, Case4), wherein the motion degree (the time change amount or the temporal index) is clearly distinguished based on the time reference value T1 and the detail degree (the space change amount or the spatial index) is clearly distinguished based on the space reference value S1, as shown in FIG. 13.

In one embodiment, the test videos of the first case Case1 can include a plurality of first frame videos 710 that are motionless and have small details, such that the temporal index (the time change amount) is smaller than the time reference value T1 and the spatial index (space change amount) is smaller than the space reference value S1.

The test videos of the second case Case2 can include a plurality of second frame videos 720, 722, 724 having the temporal index (the time change amount) greater than the time reference value T1 and the spatial index (the space change amount) less than the space reference value S1 due to a large amount of motion and a small amount of detail.

The test videos of the third case Case3 can include a plurality of third-frame videos 730 having the temporal index (the time change amount) less than the time reference value T1 and the spatial index (the space change amount) greater than the space reference value S1 due to the lack of motion and high detail.

The test videos of the fourth case Case4 can include a plurality of four-frame videos 740, 742, 744 having the temporal index (the time change amount) greater than the time reference value T1 and the spatial index (the space change amount) greater than the space reference value S1 due to a large amount of motion and detail.

The measurement device 3000 can measure the driving frequency and a resolution by taking videos of the first to fourth cases (Case1, Case2, Case3, Case4) displayed sequentially on the display device 1000, and can supply the measurement results to the electronic device 2000.

The electronic device 2000 can receive measurement results of the test videos Case1, Case2, Case3, Case4 displayed on the display device 1000 from the measurement device 3000. From the measurement results of the test videos Case1, Case2, Case3, Case4 of the display device 1000, the electronic device 2000 can determine whether the driving frequency and a resolution change according to the test videos Case1, Case2, Case3, Case4, thereby confirming if of the display device 1000 is applied according to one embodiment.

In one embodiment, the electronic device 2000 can determine that the display device 1000 according to one embodiment has not been applied if it is determined that there is no change in the resolution and driving frequency (Refresh Rate) from the measurement results of the videos of the first to fourth cases Case1, Case2, Case3, Case4 that having different motion degrees (the time change amount or the temporal index) and detail degrees (the space change amount or the spatial index), as shown in the graph 750 representing a relationship between the spatial index and the temporal index.

In one embodiment, the electronic device 2000 can determine that the display device 1000 according to one embodiment has been applied if, from the measurement results of the videos of the first to fourth cases Case1, Case2, Case3, Case4 having different motion degrees (the time change amount or the temporal index) and detail degrees (the space change amount or the spatial index), a change in the resolution and driving frequency (Refresh Rate) according to the video characteristics is identified, as shown in the graph 760 representing a relationship between the spatial index and the temporal index.

The display device 1000 according to one embodiment can display a plurality of first-frame videos 710 having motionless and have small details, for example, the temporal index is smaller than the time reference value T1 and the spatial index is smaller than the space reference value S1, by maintaining the previous driving mode (the set driving mode) without changing the resolution and driving frequency.

In one embodiment, the display device 1000 can display the plurality of first frame videos 710 having the temporal index less than the time reference value T1 and the spatial index less than the space reference value S1 in the first driving mode having the first resolution (1 times the resolution) equal to the reference resolution of the display device 1000, the first driving frequency (1 times or less the refresh rate) equal to or less than the reference driving frequency.

The display device 1000 according to one embodiment can display a plurality of second frame videos 720, 722, 724 having a large amount of motion and a small amount of detail, for example, having the temporal index greater than the time reference value T1 and the spatial index less than the space reference value S1 by adjusting the display device 1000 to the second driving mode having the second resolution that is reduced to ½ times of the first resolution of the display device 1000 and the second driving frequency (2 times the refresh rate) that is increased to 2 times of the first driving frequency.

The display device 1000 according to one embodiment can display a plurality of third-frame videos 730 having motionless and many details, for example, having the temporal index less than the time reference value T1 and the spatial index greater than the space reference value S1 by adjusting the display device 1000 to the first driving mode having the first resolution (1 times the resolution) and the first driving frequency (l times or less the refresh rate).

The display device 1000 according to one embodiment can display a plurality of four-frame videos 740, 742, 744 having a plurality of motions and many details, for example, having the temporal index greater than the time reference value T1 and the spatial index greater than the space reference value S1, by adjusting the second driving mode having the second resolution that is reduced to ½ times of the first resolution of the display device 1000 and the second driving frequency (2 times the refresh rate) that is increased to 2 times of the first driving frequency.

The display device and the driving method thereof, according to one embodiment, can analyze the video characteristics on a scan line-by-scan line basis to adaptively determine and apply an optimal resolution and driving frequency according to the video characteristics, thereby improving the video quality as well as achieving a low power consumption effect.

A display device and a driving method thereof, according to one embodiment, can analyze video characteristics and, in the case of a video with a lot of motions, reduce the resolution and drive at a high speed to clearly display a moving object without motion blur, and achieve a lower power consumption effect than when driving at a high resolution and high speed.

The display device and the driving method thereof, according to one embodiment, can analyze video characteristics to increase the resolution when the video has no motion or small motion and has many detail parts, and drive at a low speed to clearly display the detail parts in the video to improve readability and achieve a low power consumption effect.

A display device according to some aspects of the present disclosure can include a display panel, and a display driving circuit configured to analyze a motion degree of the input video signal and a detail degree of the input video signal to determine a resolution and a driving frequency and display an output video signal having the determined resolution and the driving frequency on the display panel, wherein when the motion degree of a first input video signal is less than or equal to a first time reference value and the detail degree of the first input video signal is greater than a space reference value, the display driving circuit can display a first output video signal having a first resolution and a first driving frequency on the display panel, and wherein the first resolution is equal to a reference resolution of the display panel and the first driving frequency is less than or equal to a reference driving frequency of the display panel.

In the display device according to some aspects of the present disclosure, when the motion degree of a second input video signal is greater than the first time reference value and less than or equal to a second time reference value, the display driving circuit can display a second output video signal having a second resolution and a second driving frequency on the display panel, and wherein the second resolution is less than the reference resolution and the second driving frequency is greater than the reference driving frequency.

In the display device according to some aspects of the present disclosure, when the display driving circuit displays the second output video signal having the second resolution on the display panel, the display driving circuit can drive a (2N−1)th scan line and a 2Nth scan line at the same time.

In the display device according to some aspects of the present disclosure, when the motion degree of a third input video signal is greater than the second time reference value, the display driving circuit can display a third output video signal having a third resolution and a third driving frequency on the display panel, and wherein the third resolution is less than the second resolution and the third driving frequency is greater than the second driving frequency.

In the display device according to some aspects of the present disclosure, when the display driving circuit displays the third output video signal having the third resolution, the display driving circuit can drive a (4N−3)th scan line, a (4N−2)th scan line, a (4N−1)th scan line, and a 4Nth scan line, at the same time.

In the display device according to some aspects of the present disclosure, when the motion degree of a fourth input video signal is less than or equal to the first time reference value and the detail degree of the fourth input video signal is less than or equal to the space reference value, the display driving circuit can display a fourth output video signal having a resolution equal to a previous resolution and a driving frequency equal to a previous driving frequency, or having the first resolution and the first driving frequency on the display panel.

In the display device according to some aspects of the present disclosure, the display driving circuit can calculate a time change amount by comparing a previous frame data of the input video signal with a current frame data of the input video signal for each scan line, and can determine the motion degree by comparing the time change amount with the first time reference value. The display driving circuit can calculate a space change amount by comparing the current frame data for each adjacent scan line, and can determine the detail degree by comparing the space change amount with the space reference value.

A driving method of a display device according to some aspects of the present disclosure can include obtaining a previous frame data and a current frame data of an input video, calculating a time change amount representing a motion degree of the input video by comparing the previous frame data and the current frame data for each scan line, calculating a space change amount representing a detail degree of the input video by comparing the current frame data for each adjacent scan line, and determining a resolution and a driving frequency according to the time change amount and the space change amount to display an output video signal having the determined resolution and the determined driving frequency on a display panel.

In the driving method of the display device according to some aspects of the present disclosure, when the time change amount of a first input video signal is less than or equal to a first time reference value and the space change amount of the first input video signal is greater than a space reference value, the display apparatus can display a first output video signal having a first resolution and a first driving frequency on the display panel, and the first resolution is equal to a reference resolution of the display panel and the first driving frequency is less than or equal to a reference driving frequency of the display panel.

In the driving method of the display device according to some aspects of the present disclosure, when the time change amount of a second input video signal is greater than the first time reference value and less than or equal to the second time reference value, the display apparatus can display a second output video signal having a second resolution and a second driving frequency on the display panel, and the second resolution is less than the reference resolution and the second driving frequency is greater than the reference driving frequency.

In the driving method of the display device according to some aspects of the present disclosure, when the display driving circuit displays the second output video signal having the second resolution on the display panel, the display apparatus can drive a (2N−1)th scan line and a 2Nth scan line at the same time.

In the driving method of the display device according to some aspects of the present disclosure, when the time change amount of a third input video signal is greater than the second time reference value, the display apparatus can display a third output video signal having a third resolution and a third driving frequency on the display panel, and the third resolution is less than the second resolution and the third driving frequency is greater than the second driving frequency.

In the driving method of the display device according to some aspects of the present disclosure, when the display driving circuit displays the third output video signal having the third resolution, the display apparatus can drive a (4N−3)th scan line, a (4N−2)th scan line, a (4N−1)th scan line, and a 4Nth scan line, at the same time.

In the driving method of the display device according to some aspects of the present disclosure, when the time change amount of a fourth input video signal is less than or equal to the first time reference value and the space change amount of the fourth input video signal is less than or equal to the space reference value, the display apparatus can display a fourth output video signal having a resolution equal to a previous resolution and a driving frequency equal to a previous driving frequency, or having the first resolution and the first driving frequency.

A display device according to according to some aspects of the present disclosure can include a display panel, and a display driving circuit configured to analyze a time change amount of the input video signal and a space change amount of the input video signal to determine a resolution and driving frequency and display an output video signal having the determined resolution and driving frequency on the display panel, wherein when the time change amount of a first input video signal is less than or equal to a first time reference value and the space change amount of the first input video signal is greater than a space reference value, the display driving circuit can display a first output video signal having a first resolution and a first driving frequency on the display panel, wherein when the time change amount of a second input video signal is greater than the first time reference value and less than or equal to a second time reference value, the display driving circuit can display a second output video signal having a second resolution and a second driving frequency on the display panel, and wherein first resolution is equal to a reference resolution of the display panel, the first driving frequency is less than or equal to a reference driving frequency of the display panel, the second resolution is less than the reference resolution, and the second driving frequency is greater than the reference driving frequency.

In the display device according to some aspects of the present disclosure, when the display driving circuit displays the second output video signal having the second resolution on the display panel, the display driving circuit can drive a (2N−1)th scan line and a 2Nth scan line at the same time.

In the display device according to some aspects of the present disclosure, when the time change amount of a third input video signal is greater than the second time reference value, the display driving circuit can display a third output video signal having a third resolution and a third driving frequency on the display panel, and the third driving frequency is less than the second resolution and the third driving frequency is greater than the second driving frequency.

In the display device according to some aspects of the present disclosure, when the display driving circuit displays the third output video signal having the third resolution, the display driving circuit can drive a (4N−3)th scan line, a (4N−2)th scan line, a (4N−1)th scan line, and a 4Nth scan line, at the same time.

In the display device according to some aspects of the present disclosure, when the time change amount of a fourth input video signal is less than or equal to the first time reference value and the space change degree of the fourth input video signal is less than or equal to the space reference value, the display driving circuit can display a fourth output video signal having a resolution equal to a previous resolution and a driving frequency equal to a previous driving frequency, or having the first resolution and the first driving frequency.

In the display device according to some aspects of the present disclosure, the display driving circuit can calculate a temporal index representing the time change amount by comparing a previous frame data of the input video signal with a current frame data of the input video signal for each scan line and can compare the temporal index with the first time reference value. The display driving circuit can calculate a spatial index representing the space change amount by comparing the current frame data for each adjacent scan line and can compare the spatial index with the space reference value.

The above-described feature, structure, and effect of the present disclosure are included in at least one embodiment of the present disclosure, but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various substitutions, modifications, and variations are possible within the scope of the present disclosure without departing from the spirit and scope of the present disclosure. Therefore, the scope of the present disclosure is represented by the following claims, and all changes or modifications derived from the meaning, range and equivalent concept of the claims should be interpreted as being included in the scope of the present disclosure.

What is claimed is:

1. A display device comprising:
a display panel; and
a display driving circuit configured to analyze a motion degree of an input video signal and a detail degree of the input video signal to determine a resolution and a driving frequency, and display an output video signal having the determined resolution and the driving frequency on the display panel,
wherein when the motion degree of a first input video signal is less than or equal to a first time reference value and the detail degree of the first input video signal is greater than a space reference value, the display driving circuit displays a first output video signal having a first resolution and a first driving frequency on the display panel, and
wherein the first resolution is equal to a reference resolution of the display panel, and the first driving frequency is less than or equal to a reference driving frequency of the display panel.

2. The display device of claim 1, wherein:
when the motion degree of a second input video signal is greater than the first time reference value and less than or equal to a second time reference value, the display driving circuit displays a second output video signal having a second resolution and a second driving frequency on the display panel, where the second resolution is less than the reference resolution and the second driving frequency is greater than the reference driving frequency; or
when the motion degree of a third input video signal is greater than the second time reference value, the display driving circuit displays a third output video signal having a third resolution and a third driving frequency on the display panel, where the third resolution is less than the second resolution and the third driving frequency is greater than the second driving frequency; or
when the motion degree of a fourth input video signal is less than or equal to the first time reference value and the detail degree of the fourth input video signal is less than or equal to the space reference value, the display driving circuit displays a fourth output video signal on the display panel, where the fourth output video signal has a resolution equal to a previous resolution and a driving frequency equal to a previous driving frequency, or has the first resolution and the first driving frequency.

3. The display device of claim 2, wherein:
when the display driving circuit displays the second output video signal having the second resolution on the display panel, the display driving circuit drives a (2N−1)th scan line and a 2Nth scan line at a same time, where N is a positive integer; or
when the display driving circuit displays the third output video signal having the third resolution, the display driving circuit drives a (4N−3)th scan line, a (4N−2)th scan line, a (4N−1)th scan line, and a 4Nth scan line, at a same time, where N is a positive integer.

4. A driving method of a display device, the driving method comprising
obtaining a previous frame data and a current frame data of an input video;
calculating a time change amount representing a motion degree of the input video by comparing the previous frame data and the current frame data for each scan line;
calculating a space change amount representing a detail degree of the input video by comparing the current frame data for each adjacent scan line;
determining a resolution and a driving frequency according to the time change amount and the space change amount; and
displaying an output video signal having the determined resolution and the determined driving frequency on a display panel of the display device.

5. The driving method of the display device of claim 4, wherein, in the displaying the output video signal on the display panel,
when the time change amount of a first input video signal is less than or equal to a first time reference value and the space change amount of the first input video signal is greater than a space reference value, the display device displays a first output video signal having a first resolution and a first driving frequency on the display panel, where the first resolution is equal to a reference resolution of the display panel and the first driving frequency is less than or equal to a reference driving frequency of the display panel; or
when the time change amount of a second input video signal is greater than the first time reference value and less than or equal to a second time reference value, the display device displays a second output video signal having a second resolution and a second driving frequency on the display panel, where the second resolution is less than the reference resolution and the second driving frequency is greater than the reference driving frequency; or
when the time change amount of a third input video signal is greater than the second time reference value, the display device displays a third output video signal having a third resolution and a third driving frequency on the display panel, where the third resolution is less than the second resolution and the third driving frequency is greater than the second driving frequency.

6. The driving method of the display device of claim 5, wherein, in the displaying the output video signal on the display panel,
when the display device displays the second output video signal having the second resolution on the display panel, the display driving circuit drives a (2N−1)th scan line and a 2Nth scan line at a same time, where N is a positive integer; or
when the display driving circuit displays the third output video signal having the third resolution, the display device drives a (4N−3)th scan line, a (4N−2)th scan line, a (4N−1)th scan line, and a 4Nth scan line, at a same time, where N is a positive integer.

7. A display device comprising:
a display panel; and
a display driving circuit configured to analyze a time change amount of an input video signal and a space change amount of the input video signal to determine a resolution and driving frequency, and display an output video signal having the determined resolution and driving frequency on the display panel,
wherein when the time change amount of a first input video signal is less than or equal to a first time reference value and the space change amount of the first input video signal is greater than a space reference value, the display driving circuit displays a first output video signal having a first resolution and a first driving frequency on the display panel,
wherein when the time change amount of a second input video signal is greater than the first time reference value and less than or equal to a second time reference value, the display driving circuit displays a second output video signal having a second resolution and a second driving frequency on the display panel, and
wherein the first resolution is equal to a reference resolution of the display panel, the first driving frequency is less than or equal to a reference driving frequency of the display panel, the second resolution is less than the reference resolution, and the second driving frequency is greater than the reference driving frequency.

8. The display device of claim 7, wherein when the time change amount of a third input video signal is greater than the second time reference value, the display driving circuit displays a third output video signal having a third resolution and a third driving frequency on the display panel, where the third driving frequency is less than the second resolution and the third driving frequency is greater than the second driving frequency.

9. The display device of claim 8, wherein:
when the display driving circuit displays the second output video signal having the second resolution on the display panel, the display driving circuit drives a (2N−1)th scan line and a 2Nth scan line at a same time, where N is a positive integer; or
when the display driving circuit displays the third output video signal having the third resolution, the display driving circuit drives a (4N−3)th scan line, a (4N−2)th scan line, a (4N−1)th scan line, and a 4Nth scan line, at a same time, where N is a positive integer.

10. The display device of claim 7,
wherein the display driving circuit calculates a temporal index representing the time change amount by comparing a previous frame data of the input video signal with a current frame data of the input video signal for each scan line, and compares the temporal index with the first time reference value, and
wherein the display driving circuit calculates a spatial index representing the space change amount by comparing the current frame data for each adjacent scan line, and compares the spatial index with the space reference value.
